(19) United States
(12) Patent Application Publication
(10) Pub. No.: US 2020/0237591 A1
(43) Pub. Date: Jul. 30, 2020

(54) MOTORIZED WHEELCHAIR AND CONTROL METHOD THEREOF

(71) Applicant: LG ELECTRONICS INC., Seoul (KR)

(72) Inventors: Haemin CHOI, Seoul (KR); Wondong DO, Seoul (KR); Daekeun YOON, Seoul (KR); Jaebeom IM, Seoul (KR); Induk CHOI, Seoul (KR)

(21) Appl. No.: 16/715,128

(22) Filed: Dec. 16, 2019

(30) Foreign Application Priority Data
Jan. 29, 2019 (KR) 10-2019-0011297

(51) Int. Cl. A61G 5/12; A61G 5/04; A61G 5/08; A61G 5/10; B60W 30/09; B60Q 9/00; B60W 50/16

(52) U.S. Cl. CPC A61G 5/128; A61G 5/048; A61G 5/08; A61G 5/1005; A61G 2203/72; B60Q 9/008; B60W 50/16; A61G 2203/14; A61G 2203/40; B60W 30/09

(57) ABSTRACT

Disclosed herein is a method of controlling a motorized wheelchair, the motorized wheelchair including a seat frame supporting a seat, a back frame to which the seat frame is detachably connected, a first main wheel and a second main wheel respectively installed at both lower ends of the back frame, an inclination detecting sensor which detects an inclination, and a controller which controls the main wheel and the second main wheel, the method includes receiving an input for a turning operation, calculating an inclination angle of a running ground by the inclination detecting sensor, and determining whether the inclination angle is greater than a reference angle.

### CROSS-REFERENCE TO RELATED APPLICATIONS

The present application claims priority under 35 U.S.C. 119 and 35 U.S.C. 365 to Korean Patent Application No. 10-2019-0011297, filed in Korea on Jan. 29, 2019, which is hereby incorporated by reference in its entirety.

### BACKGROUND OF THE INVENTION

### 1. Field of the Invention

The present disclosure relates to a motorized wheelchair and a control method thereof.

### 2. Discussion of the Related Art

A motorized wheelchair equipped with an electric motor has been provided as an apparatus for assisting people with difficulty in walking such as the disabled and the elderly. The electric motor is generally called a motor. In addition, the motor provides a driving force to drive the motorized wheelchair.

In a conventional motorized wheelchair, since the volume and weight occupied by the motor are relatively large, there is a problem in that the motorized wheelchair is difficult to ride the vehicle and is inconvenient to be stored.

In order to solve those problems, Korean Patent Publication No. 2002-0063053 (hereinafter referred to as prior art document 1) published on Aug. 1, 2002 discloses a wheelchair in which a small DC motor or a brushless (DC) motor is connected to each of wheels to reduce the volume of a driving device and the wheelchair is capable of being folded and a driving control method thereof.

However, since the prior art document 1 merely discloses a technique for minimizing the size of the motor and controlling the running speed of each wheel, there is a limit to minimize the volume of the motorized wheelchair. In addition, according to the prior art document 1, the motorized wheelchair has a structure that is still difficult to be disassembled and therefore, there is a problem of low installation convenience.

In addition, considering the characteristics of a user who uses a motorized wheelchair in general, the motorized wheelchair should be able to assist the user's ability to recognize a risk. Therefore, the motorized wheelchair needs to be provided with various and precise risk detection means and recognition means for the user's safety compared to general walk assistance devices.

However, Prior Art document 1 has a problem that it does not disclose any means and methods capable of assisting the user's ability to recognize risk.

In order to solve such a problem, Korean Patent Publication No. 10-2011-0118965 (hereinafter, referred to as Prior Art document 2) published on Nov. 2, 2011 discloses an autonomous wheelchair system using gaze recognition, which allows a user to operate the motorized wheelchair using the gaze of the user with inconvenient behavior.

The prior art document 2 discloses a technique for adjusting the motorized wheelchair through recognition of the user's gaze by detecting the user's pupil. In addition, the prior art document 2 discloses an ultrasonic sensor module for detecting an obstacle and an autonomous driving mode for controlling movement based on a result of detection by the ultrasonic sensor module.

On the other hand, considering the general characteristics of the user using the motorized wheelchair, the motorized wheelchair needs to quickly grasp the surrounding running environment during running. In other words, the motorized wheelchair needs to able to accurately detect a risk factor while running and inform a user of the risk factor.

When the motorized wheelchair does not detect a risk factor such as a height difference of the ground, an obstacle in the front and rear directions, or the like, it may lead to a big accident while running. In addition, when unnecessary malfunction occurs as a result of inaccurate sensing, it may cause great inconvenience to the user.

However, in the prior art document 2, the motorized wheelchair is merely controlled based on risk perception through the user's gaze while autonomous driving is being performed as a result of detection by a plurality of ultrasonic sensors, so that the motorized wheelchair cannot detect various risk factors centered on users, such as a height difference (or step) of the running ground and there is a problem that the recognition of risks during autonomous driving depends only on the recognition contents of the users.

In addition, according to the prior art document 2, there is a problem that there is no way to enable the user having a variety of inconveniences to recognize the risk. Due to this, a user who has a limited ability in the cognitive ability, such as a visually impaired or a hearing impaired, has difficulty in recognizing a risk when using a motorized wheelchair.

In addition, in the prior art document 2, ten ultrasonic sensors are provided as a method for improving an obstacle detection capability.

However, as the use of a plurality of sensors increases the manufacturing cost, it is difficult to provide a more economical motorized wheelchair.

### SUMMARY OF THE INVENTION

The present disclosure is to solve the above problems, and an object of the present disclosure is to provide a motorized wheelchair which enables easy disassembly and installation and minimize volume when not in use and a control method thereof.

In addition, an object of the present disclosure is to provide a motorized wheelchair which is provided with various risk detecting means and user recognition means to allow the user of the motorized wheelchair to accurately recognize and avoid a risk and a control method thereof.

In addition, an object of the present disclosure is to provide a motorized wheelchair capable of enabling a user to recognize a detected risk by variously stimulating the user's senses such as sight, hearing, and tactile sense, and a control method thereof.

In addition, an object of the present disclosure is to provide a motorized wheelchair that improves the risk recognition ability and is economically advantageous by proposing an optimal structure for a plurality of detecting means that may have a mutual effect in detecting a risk.

In order to achieve the above objects, a motorized wheelchair according to the present disclosure provides a number of structural features to minimize misrecognition while structurally extending a detection range of the detecting sensor to the maximum.

According to an embodiment, a motorized wheelchair may include a seat frame forming a frame, on which a user is able to sit, and a seat assembly connected to an upper portion of the seat frame.

Furthermore, the motorized wheelchair may further include a foot guide rotatably connected to a front end of the seat frame and a back frame provided with a backrest connected to an upper portion thereof, the seat frame being slidably inserted into a center portion of the back frame.

Furthermore, the motorized wheelchair may further main wheels connected to both lower ends of the back frame, and a front obstacle detecting sensor connected to a most forward portion of the seat frame to detect an obstacle in front of the seat frame. Due to this, it is possible to easily detect an object in front of the motorized wheelchair.

Furthermore, the sheet assembly may include a sheet formed of a fabric.

Furthermore, the foot guide may be disposed to be inclined upward such that the front end is disposed at a higher position than the lower end. In other words, the front height difference sensor may be disposed to be inclined upward from the ground. Accordingly, the front height difference sensor may detect a height difference (or a step) of the ground area which is further expanded.

Furthermore, the foot guide may include a rotating shaft connected to a lower end of the seat frame, and a rotating plate extending such that a front end is disposed to be lower than a rear end and formed such that the rear end surrounds the rotating shaft.

Furthermore, the rotating plate, which is located in the front end portion, forms a sensor exposure hole that is open downward, and the front height difference sensor may be inserted into the sensor exposure hole. Accordingly, the front height difference sensor is exposed to the ground and disposed to be inclined upwardly to sense a wider area.

The seat frame may include a rear frame located on a rear side, leg frames extending forward from both side ends of the rear frame, and a front frame connecting the lower ends of the leg frames.

The front obstacle detecting sensor may be connected to front ends of the leg frames. Accordingly, the front obstacle detecting sensor is located in the front of the motorized wheelchair, thereby improving the obstacle recognition performance.

Furthermore, the leg frame may extend from the rear frame to a first point L1 in front and may extend to be inclined downward from the first point to a second point L2 located in front of the first point. That is, the leg frame may have a ‘<’ shape.

The front obstacle detecting sensor may be connected to a cutout groove formed at a position corresponding to the second point. Due to this, the front obstacle detecting sensor may prevent the interference by the other configuration of the motorized wheelchair.

In addition, the leg frame may extend to be inclined downward from the second point L2 to a third point L3 located behind the second point. Due to this, the foot guide rotatably connected to the front frame connected to the lower end of the leg frame may be rotated toward the inner rear of the leg frame so as not to affect the front obstacle detecting sensor when not in use.

In addition, the cutout groove may form a plane perpendicular to the ground. Accordingly, the front obstacle detecting sensor may sense a wider area.

In addition, the front obstacle detecting sensor may include a sensor case provided with a light emitting diode (LED). Accordingly, it is possible to allow people around the motorized wheelchair to predict the running of the motorized wheelchair or warn the people about the running of the motorized wheelchair.

The seat assembly may further include a base plate supporting the seat, and a battery fixed to a lower side of the base plate, and the seat frame and the back frame may be formed in a structure of a switch for operations of turning on/off power provided from the battery. Accordingly, the motorized wheelchair is provided in which the seating part and the backrest part are detachably connected to each other, and the electronic parts may be driven only when the seating part and the backrest part are connected to each, thereby improving safety. That is, when the seat frame is separated from the back frame, the power supply may be stopped from the battery.

In addition, a hinge part to which the foot guide is connected may be formed at the front end of the front frame.

In addition, the foot guide may further include a first footrest and a second footrest hinged to both side ends of the rotating plate.

In addition, the main wheel may include a drive motor of an outer rotor type and a brake.

In another aspect, the motorized wheelchair according to the present disclosure may provide a control method that may prevent the height difference risk and obstacle risk detected in the front area.

Such a control method of the motorized wheelchair in which a first part for seating of a user and a second part for a backrest are detachably connected to each other includes determining a position of a foot guide rotatably connected to a lower end of a seat frame provided in the first part.

The control method of the motorized wheelchair may further include receiving a detection signal from one of a front obstacle detecting sensor installed in a front end of the seat frame and a front height difference sensor installed in the foot guide.

The control method of the motorized wheelchair may further include determining whether the detection signal is a signal of the front obstacle detecting sensor or a signal of the front height difference sensor.

In this case, an obstacle risk prevention of preventing collision with a detected obstacle may be performed when the detection signal is the signal of the front obstacle detecting sensor and

a height difference risk prevention of avoiding a detected height difference may be performed when the detection signal is the signal of the front height difference sensor. Due to this, it is possible to improve the safety of the user using the motorized wheelchair.

In addition, the control method of the motorized wheelchair may include turning off the operation of the front height difference sensor when it is determined that the foot guide is at a position of being completely rotated upward

In addition, in the control method of the motorized wheelchair, the position of the foot guide may be determined based on the detection signal of the front height difference sensor.

In addition, the front height difference sensor may be selectively operated according to rotation of the foot guide.

The height difference risk prevention may include outputting a warning to at least one of a display, a speaker, and a control stick provided with a vibrating device which are provided in the second part.

The warning may include a warning screen output on the display, a warning sound output to the speaker, a speech guidance, and vibration of the control stick.

In addition, the height difference risk prevention may further include determining whether the detected height difference is greater than or equal to a preset reference height difference, and an emergency braking step of operating a brake of the main wheels provided in the second part when the detected height difference is greater than or equal to the reference height difference.

In addition, the height difference risk prevention may further include determining whether a user confirmation or a backward is input after the warning is output, and

releasing braking of the main wheels, when it is determined that the user confirmation or the backward is input.

In addition, the obstacle risk prevention step may include outputting a warning to at least one of a display, a speaker, and a control stick provided with a vibrating device which are provided in the second part.

In addition, the obstacle risk prevention step may further include determining whether the detection signal is or a user confirmation is input.

In addition, the obstacle risk prevention step may further include determining a distance to the obstacle when it is determined that the detection signal or there is no user confirmation input; and changing the warning when a distance to the obstacle reaches a preset distance.

In addition, the changing of the warning may include flickering of a warning screen output to the display, changing of an interval of a warning sound output to the speaker, and changing of vibration of the vibrating device.

According to the present disclosure, it is possible to store the motorized wheelchair in a relatively small loading space.

In addition, since the motorized wheelchair is easily disassembled into two parts, it is easy to carry the motorized wheelchair when not in use.

In addition, the disassembled two parts may be fitted into each other to be stored as one body, thus minimizing the total volume, and facilitating management.

In addition, the disassembled two parts may be easily connected to each other, thereby improving convenience in installation.

In addition, it is possible to accurately detect a variety of risk factors, such as dangerous obstacles, the road surface environment during running of the motorized wheelchair and enable a user to recognize the detected risk in various ways, thereby improving running safety and reliability.

In addition, it is possible to detect a height difference (a step) of the running surface along the running path, thereby preventing an accident such as an overturning of the motorized wheelchair and a fall of the user in advance.

In addition, when an environment that may be dangerous to the user is detected, the control of the motorized wheelchair is first provided in advance to prevent an accident, and secondly, the control according to the confirmation of the user is provided, thereby minimizing user inconvenience and performing safe running.

### BRIEF DESCRIPTION OF THE DRAWINGS

FIG. 1 is a front perspective view showing a motorized wheelchair according to an embodiment of the present disclosure.

FIG. 2 is a rear perspective view showing a motorized wheelchair according to an embodiment of the present disclosure.

FIG. 3 is a perspective view showing a state in which a motorized wheelchair is disassembled according to an embodiment of the present disclosure

FIG. 4 is a side view showing a motorized wheelchair according to an embodiment of the present disclosure,

FIG. 5 is a perspective view showing a seat frame and a front obstacle detecting sensor according to an embodiment of the present disclosure.

FIG. 6 is a bottom view showing a seat frame and a foot guide connected to each other according to an embodiment of the present disclosure,

FIG. 7 is a perspective view showing a foot guide according to an embodiment of the present disclosure,

FIG. 8 is an exploded view showing some components of a foot guide according to an embodiment of the present disclosure.

FIG. 9 is a block diagram showing a control configuration of a motorized wheelchair according to an embodiment of the present disclosure.

FIG. 10 is a flowchart of a method for controlling a motorized wheelchair according to an embodiment of the present disclosure.

FIG. 11 is a flowchart illustrating step S100 of FIG. 10 in detail.

FIG. 12 is a flowchart illustrating step S200 of FIG. 10 in detail.

### DETAILED DESCRIPTION OF THE PREFERRED EMBODIMENTS

Reference will now be made in detail to the embodiments of the present disclosure, examples of which are illustrated in the accompanying drawings.

In the following detailed description of the preferred embodiments, reference is made to the accompanying drawings that form a part hereof, and in which is shown by way of illustration specific preferred embodiments in which the invention may be practiced. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the invention, the description may omit certain information known to those skilled in the art. The following detailed description is, therefore, not to be taken in a limiting sense.

Also, in the description of embodiments, terms such as first, second, A, B, (a), (b) or the like may be used herein when describing components of the present invention. Each of these terminologies is not used to define an essence, order or sequence of a corresponding component but used merely to distinguish the corresponding component from other component(s).

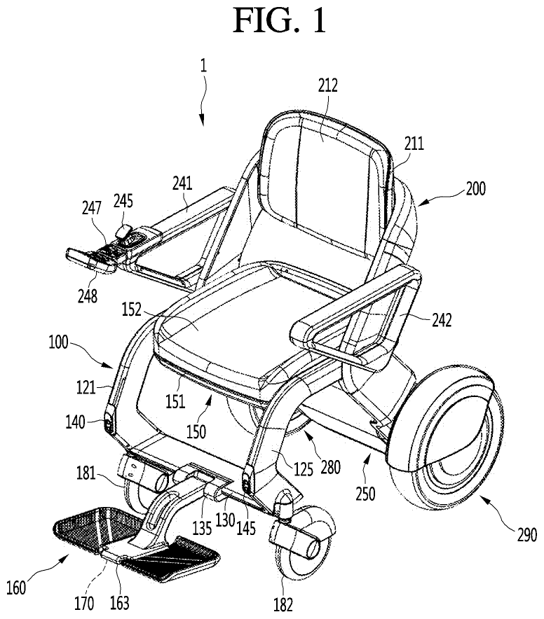

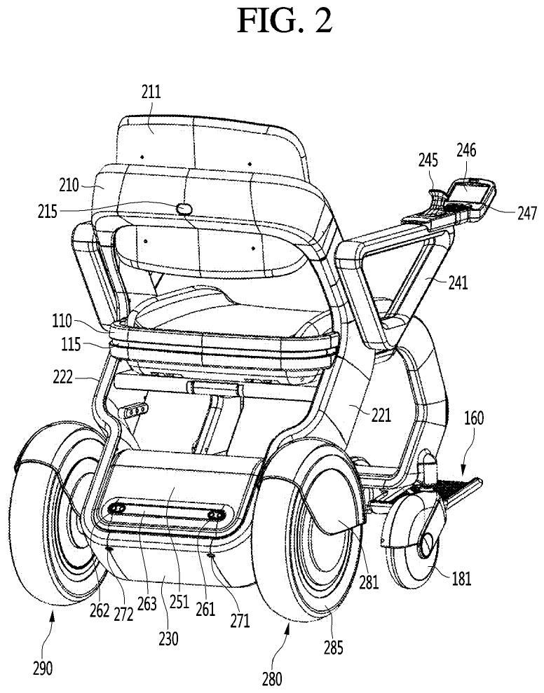

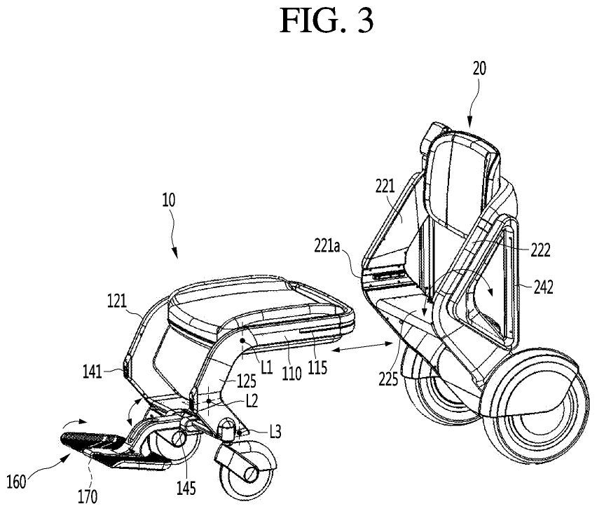

FIG. 1 is a front perspective view showing a motorized wheelchair according to an embodiment of the present disclosure, FIG. 2 is a rear perspective view showing a motorized wheelchair according to an embodiment of the present disclosure, and FIG. 3 is a motorized wheelchair which is disassembled according to an embodiment of the present disclosure.

FIGS. 1 to 3, a motorized wheelchair 1 according to an embodiment of the present disclosure may include a seat frame 100, front obstacle detecting sensors 140 and 145 installed on the seat frame 100, a foot guide 160 to be rotatably connected to the seat frame 100, sub-wheels 181, 182 connected to the seat frame 100 to guide driving, and a seat assembly 150 supported by the seat frame 100.

The seat frame 100 may form a frame to which the seat assembly 150 is connected therein. That is, the seat frame 100 may form a space in which the seat assembly 150 is mounted.

The seat frame 100 may extend to form a closed curve in which both ends thereof coincide each other. For example, the seat frame 100 may have a shape of when viewed from the side.

The seat frame 100 may include a rear frame 110, leg frames 121 and 125 respectively extending forward from both side ends of the rear frame 110, and a front frame 130 connected to lower ends of the leg frames 121 and 125.

That is, the rear frame 110 may form a rear portion of the seat frame 100, the leg frames 121 and 125 may form both side portions of the seat frame 110, and the front frame 130 may form a front portion of the seat frame 100.

The rear frame 110 may extend in a lateral direction to cover the rear surface of the seat assembly 150.

The leg frames 121 and 125 may extend forward from the both side ends of the rear frame 110 to cover both side surfaces of the seat assembly 150.

The leg frames 121 and 125 may include a first leg frame 121 extending from one side end of the rear frame 110 and a second leg frame 125 extending from the other side end of the rear frame 110.

For example, the first leg frame 121 may extend from a right end of the rear frame 110, and the second leg frame 125 may extend from a left end of the rear frame 110. Therefore, the first leg frame 121 may be laterally spaced apart from the second leg frame 125.

The first leg frame 121 and the second leg frame 125 may be formed in the same shape. That is, the first leg frame 121 and the second leg frame 125 may be formed to be symmetrical with each other.

In addition, the leg frames 121 and 125 may extend to be bent a plurality of times. In other words, each of the leg frames 121 and 125 may extend such that the extending direction thereof is changed at least one or more times

That is, the leg frames 121 and 125 may extend forward and then downward. For example, the leg frames 121 and 125 may have a shape of an approximately when viewed from the side.

As a result, upper portions of the leg frames 121 and 125 may extend forward to support the seat assembly 150. The lower portions of the leg frames 121 and 125 may be connected to the front frame 130 to support a foot guide 160 to be described later.

Furthermore, the leg frames 121 and 125 may extend horizontally from one side end of the rear frame 110 to a first point L1 in front, extend to be inclined downward from the first point L1 to a second point L2 located in front of the first point L1, and extend to be inclined downward from the second point L2 to a third point L3 located behind the second point L2.

For example, the leg frames 121 and 125 may have an approximately ‘hook’ shape when viewed from the side. As another example, the front portions of the leg frames 121 and 125 may have a shape of ‘leg with knee bent’ or ‘<’ when viewed from the side. Here, the knee corresponds to the second point L2.

Due to this, the second point L2 (or the knee point) may be disposed in a most forward portion from the leg frames 121 and 125. That is, the second point L2 (or the knee point) may be understood as a front end of the leg frame 121 or 125.

In addition, front ends of the leg frames 121 and 125 may be positioned at the most forward portion of the seat frame 100. As a result, the front ends of the leg frames 121 and 125 may be understood as the front end of the seat frame 100.

Meanwhile, a cutout groove 126 to be described later may be formed at the second point L2 (or the knee point). The front obstacle detecting sensors 140 and 145 may be installed in the cutout groove 126.

The front obstacle detecting sensors 140 and 145 may include an ultrasonic sensor (USS).

Furthermore, the front obstacle detecting sensors 140 and 145 may include an ultrasonic sensor capable of detecting a change in distance. Accordingly, since the front obstacle detecting sensors 140 and 145 are able to detect how much a distance to an obstacle in front thereof vary, it is possible to perform control to raise a warning level to the user as the distance between the obstacle and the motorized wheelchair 1 becomes closer.

The front obstacle detecting sensors 140 and 145 may be installed at the front ends of the leg frames 121 and 125. That is, the front obstacle detecting sensors 140 and 145 may be connected to the front end of the seat frame 100.

In addition, the front obstacle detecting sensors 140 and 145 may include a first front obstacle detecting sensor 140 connected to the first leg frame 121, and a second front obstacle detecting sensor 145 connected to the second leg frame 125.

As a result, since the front obstacle detecting sensors 140 and 145 are installed at the most forward portion of the seat frame 100, an obstacle detecting range may be extended to the maximum in the running direction of the motorized wheelchair 1. That is, the front obstacle detecting sensors 140 and 145 may be installed to minimize interference with other components.

The motorized wheelchair 1 according to the embodiment of the present disclosure may structurally expand a sensing range of the front obstacle detecting sensors 140 and 145 to the maximum and may provide a plurality of structural features to minimize misrecognition. A detailed description thereof will be given later.

The rear portions of the leg frames 121 and 125 may be slidably inserted into a back frame 200 to be described later. In detail, the rear portion of the first leg frame 121 and the rear portion of the second leg frame 125 may be slidably inserted into or slidably drawn out an insertion groove 221a formed on an inner surface of the back frame 200.

To this end, the leg frames 121 and 125 may include a slide groove 115 for guiding coupling with the back frame 200.

The slide groove 115 may be recessed inward from the outer surfaces of the leg frames 121 and 125. The slide groove 115 may extend in a straight line toward the rear ends of the leg frames 121 and 125.

Of course, the slide groove 115 may extend from the first leg frame 121 to the second leg frame 125 via the rear frame 110.

A slide guide 223 formed in the insertion groove 221a to be described later may be inserted into the slide groove 115. As the slide guide 223 inserted into the slide groove 115 moves forward or backward, the seat frame 100 may be easily separated from or connected to the back frame 200.

The leg frames 121 and 125 may further include wheel coupling parts 124 and 129 to which the sub wheels 181 and 182 for driving of the motorized wheelchair 1 are connected.

The wheel coupling parts 124 and 129 may be formed at the lower ends of the outer surfaces of the leg frames 121 and 125.

In more detail, the wheel coupling parts 124 and 129 may include a first wheel coupling part 124 formed in the first leg frame 121 and a second wheel coupling part 129 formed in the second leg frame 125.

The first wheel coupling part 124 may be located at the lower end of the outer surface of the first leg frame 121. Similarly, the second wheel coupling part 129 may be located at the lower end of the outer surface of the second leg frame 125.

That is, the sub wheels 181 and 182 may be connected to the lower end of the seat frame 100 to enable a rolling motion.

The sub wheels 181 and 182 may be subordinate to the main wheels 280 and 290 that provide a driving force, which will be described later to perform the rolling motion. That is, the sub wheels 181 and 182 may guide the driving of the motorized wheelchair 1 by assisting the main wheels 280 and 290. For example, the sub wheels 181 and 182 may include casters. Of course, the sub wheels 181 and 182 may be provided with a separate driving device.

The sub wheels 181 and 182 may include a first sub wheel 181 connected to one of the leg frames 121 and 125 to perform the rolling motion and a second wheel 182 connected to the other of the leg frames 121 and 125 to perform the rolling motion.

In detail, the first sub wheel 181 may be connected to the first wheel coupling part 124. The second sub wheel 182 may be connected to the second wheel coupling part 124. That is, the first sub wheel 181 may be positioned to be spaced apart from the second sub wheel 182 in a lateral direction. Therefore, since the first sub wheel 181 and the second sub wheel 182 support both lower ends of the seat frame 100, the motorized wheelchair 1 may stably drive together with the main wheels 280 and 290.

The front frame 130 may be connected to the lower ends of the leg frames 121 and 125. For example, the front frame 130 may extend from the lower end of the first leg frame 121 to the lower end of the second leg frame 125. Here, the front frame 130 may be located inside the leg frames 121 and 125, and the wheel coupling parts 124 and 129 may be located outside the leg frames 121 and 125.

In other words, the front frame 130 may extend from lower ends of the leg frames 121 and 125 corresponding to the third point L3. Therefore, the foot guide 160 connected to the front frame 130 may be rotated backward on the inside of the leg frames 121 and 125 when not in use. According to this, there is no interference with the front obstacle detecting sensors 140 and 145.

The front frame 130 may extend in a lateral direction to connect the lower ends of the first leg frame 121 and the second leg frame 125.

The front end of the front frame 130 may be located more backward than the front ends of the leg frames 121 and 125. Therefore, the obstacle detecting sensors 140 and 145 installed at the front ends of the leg frames 121 and 125 may detect an obstacle without interference with the front frame 130.

The front frame 130 may include a hinge part 135 to which the foot guide 160 is able to be rotatably connected.

The hinge part 135 may be formed at the front end of the front frame 130. In addition, the hinge part 135 may be recessed backward from the center portion of the front end of the front frame 130 to form a space in which the foot guide 160 is installed.

In detail, both sides of the hinge part 135 may define a space in which the foot guide 160 is installed. The both sides of the hinge part 135 may be spaced apart from each other to face each other.

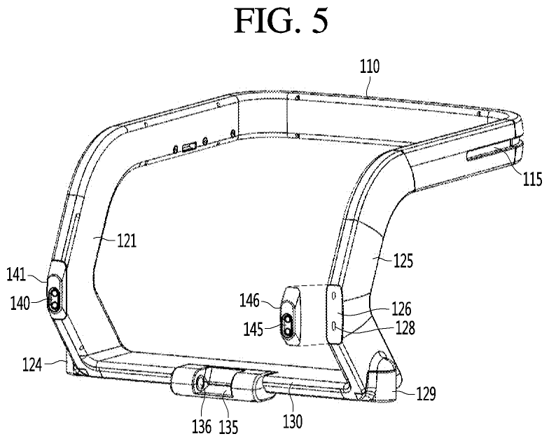

In addition, insertion holes 136 (see FIG. 5) to which a rotating shaft 161 of the foot guide 160 is rotatably connected may be formed in both side surfaces of the hinge part 135. For example, two side ends of the rotating shaft 161 may be rotatably connected to the insertion holes 136 respectively formed in both side surfaces of the hinge part 135.

That is, the foot guide 160 may be rotatably connected to the front frame 130. In addition, the foot guide 160 may be rotatably connected to rotate upward of the hinge part 135 (see arrow in FIG. 3).

In detail, the foot guide 160 may include a rotating shaft 161 connected to the hinge part 135, a rotating plate 163 connected to the rotating shaft 161 and extending forward, and footrests 168 and 169 connected to both sides of the rotating plate 163 to support both feet of the user.

The rotating shaft 161 may be connected to the hinge part 135. As an example, the rotating shaft 161 may be rotatably fitted to both side surfaces of the hinge part 135.

The rotating plate 163 may rotate along the rotation of the rotating shaft 161. That is, the rotating plate 163 may rotate in a clockwise direction around the rotating shaft 161.

The footrests 168 and 169 may be rotatably connected to the rotating plate 163. For example, the footrests 168 and 169 may be connected to the center of a side end of the rotating plate 163 to rotate upwards. A detailed configuration of the foot guide 160 will be described later.

The seat assembly 150 may include a base plate 151 connected to the seat frame 100, a seat 152 installed on an upper surface of the base plate 151, a battery (not shown) that provides power, and a battery cover extending downward from the base plate 151 to accommodate the battery.

The base plate 151 may be connected to an upper portions of the leg frames 121 and 125. In detail, the base plate 151 may be provided such that an upper portion of the first leg frame 121 and an upper portion of the second leg frame 125 are connected to each other. For example, the second base plate 151 may extend from an inner surface of the first leg frame 121 extending in a straight line from the rear frame 110 to an inner surface of the second leg frame 125 extending in a straight line from the rear frame 110.

That is, the base plate 151 may extend to shield an inner upper space formed by the rear frame 110, the first leg frame 121, and the second leg frame 125.

The seat 152 may be located over the base plate 151. The seat 152 may be formed of a fabric. For example, the seat 152 may be made of a soft and resilient material such that the user is able to sit comfortably.

The battery may be located below the base plate 151. The battery may supply power to the electronic parts of the motorized wheelchair 1, such as drive motors 283 and 293 provided in the main wheels 280 and 293, various board PCBs, inverters and converters provided in the control box 250, a control stick 245 for controlling driving, a display 246, an input button 247 and the like.

The battery may supply power to the electronic parts only when the seat frame 100 is connected to the back frame 200.

The battery cover may extend downward along the circumference of the base plate to cover the battery from below. That is, the battery cover may be connected to the lower side of the base plate 151, and the battery may be installed in an inner space formed by the battery cover 154 and the base plate 151.

On the other hand, the motorized wheelchair 1 may further include a front height difference sensor 170 capable of detecting the height difference of a running ground.

Hereinafter, the ground on which the motorized wheelchair 1 drives may be referred to as a “running surface”.

The front height difference sensor 170 may include an infrared position sensitive device (PSD).

The front height difference sensor 170 may be installed in the foot guide 160. In detail, the front height difference sensor 170 may be connected to the front portion of the foot guide 160 so as to face the ground.

In addition, the foot guide 160 may be disposed to be inclined upwardly from the running surface (or the ground) to maximize the performance of the front height difference sensor 170. A detailed description thereof will be given later.

When the foot guide 160 is rotated counterclockwise toward the front to support the user's foot (hereinafter, ‘normal position’), the foot guide 160 is located further forwards than the sub wheels 181 and 182.

Therefore, the front height difference sensor 170 may detect a height difference (step) of the running surface, to which the motorized wheelchair 1 has not yet reached along the running direction of the motorized wheelchair 1, in advance.

Accordingly, the motorized wheelchair 1 may stop running or guide the user to run on a different route when the height difference detected by the front height difference sensor 170 is higher than a reference, protecting the user from an accident such as overturning or falling.

The motorized wheelchair 1 may further include a back frame 200 that is detachably connected to the seat frame 100, a back plate 211 connected to the back frame 200 to support the user's back and a cushion 121.

The cushion 212 may be formed of the same material as the seat 152. The back plate 211 may be connected to the rear side of the cushion 212.

The back plate 211 may be integrally connected with the cushion 212. Thus, the back plate 211 and the cushion 212 may be referred to as a “backrest”.

The back plate 211 may be connected to the front surface of the back frame 200. Here, the back plate 211 and the cushion 212 may be positioned higher than the seat 152.

The back plate 211 may be connected to the front surface of the back frame 200. Here, the back plate 211 and the cushion 212 may be positioned at a position higher than the seat 152.

The back frame 200 may form a frame into which the seat frame 100 is vertically inserted, on the inside thereof. That is, the back frame 200 may form a space that is open in the front and rear direction by the width of the seat frame 100 such that the seat frame 100 is able to be slidably inserted into the inner surface.

The back frame 100 may extend to form a closed curve in which both ends thereof coincide each other. For example, the back frame 200 may have a shape of ‘<’ when viewed from the side.

The back frame 200 may include an upper frame 210, side frames 221 and 222 extending downward from both side ends of the upper frame 210, and a low frame 230 connected to lower ends of the side frames 221 and 222.

The upper frame 210 may form an upper portion of the back frame 200, the side frames 221 and 222 may form both side portions of the back frame 200, and the low frame 230 may form a lower portion of the back frame 200.

The motorized wheelchair 1 may further include a rear camera 215 installed in the upper frame 210.

The rear camera 215 may be installed in the upper frame 210 such that lens is exposed to the rear. For example, the rear camera 215 may be installed in a rear surface of the upper frame 210. Accordingly, the rear camera 215 may photograph the rear of the motorized wheelchair 1.

The upper frame 210 may fix the back plate 211 and the cushion 212. Therefore, the upper frame 210 may be located in an upper portion of the motorized wheelchair 1 so as to support the back of the user.

The upper frame 210 may extend in a lateral direction to cover the back plate 211 from the rear.

The side frames 221 and 222 may extend downward from both side ends of the upper frame 210.

In detail, the side frames 221 and 222 may include a first side frame 221 extending from one side end of the upper frame 210 and a second side frame 222 extending from the other side end of the upper frame 210.

For example, the first side frame 221 may extend from a right end of the upper frame 210, and the second side frame 222 may extend from a left end of the upper frame 210. Therefore, the first side frame 221 may be laterally spaced apart from the second side frame 222.

The first side frame 221 and the second side frame 222 may be formed in the same shape. That is, the first side frame 221 and the second side frame 222 may be formed to be symmetrical with each other.

In addition, the side frames 221 and 222 may extend such that the extending direction thereof is changed at least one or more times.

In detail, the side frames 221 and 222 may extend to be downwardly inclined forward from the both side ends of the upper frame 210 to a point at which the seat frame 100 is connected, and extend to be downwardly inclined rearward from the point at which the seat frame 100 is connected. For example, the side frames 221 and 222 may have a shape of substantially ‘<’ when viewed from the side.

Due to this, the coupling of the seat frame 100 and the back frame 200 is relatively close to the center of gravity of the motorized wheelchair 1, thus achieving a more stable coupling. In addition, the seat 152 and the cushion 212 may be provided at an angle at which the hip and back of the user are comfortably supported, thus achieving a more human-friendly comfort.

The side frames 221 and 222 may be formed with an insertion groove 221a into which the seat frame 100 is inserted.

The outer surfaces of the leg frames 121 and 125 may be slidably inserted into the insertion groove 221a. For example, the insertion groove 221a may be formed such that the leg frames 121 and 125 are fitted thereto in the front-rear direction.

That is, the insertion groove 221a may be formed at a point where the side frames 221 and 222 and the seat frame 100 are connected to each other.

The insertion groove 221a may be formed to be outwardly recessed in the inner surfaces of the side frames 221 and 222. The insertion groove 221a may be formed such that a recessed space extends in the front-rear direction. For example, the insertion groove 221 may be formed such that the recessed space extends from the front end to the rear end in the center portion of the side frames 221 and 222.

The insertion groove 221a formed in the first side frame 221 may be referred to as a first insertion groove 221a, and the insertion groove (not shown) formed in the second side frame 222 may be referred to as a second insertion groove

An outer surface of the first leg frame 121 may be slidably inserted into the first insertion groove 221a, and an outer surface of the second leg frame 125 is slidably inserted into the second insertion groove (not shown).

The side frames 221 and 222 may further include a slide guide 223 positioned in the insertion groove 221a and protruding from the inner surfaces of the side frames 221 and 222.

The slide guide 223 may be inserted into the slide groove 115 formed in the leg frames 121 and 125. That is, the slide guide 223 and the slide groove 115 may guide the leg frames 121 and 125 to be connected to the insertion groove 221a.

The slide guide 223 may protrude in a shape corresponding to the slide groove 115. The slide guide 223 may extend in the front-rear direction.

The back frame 200 may further include a guide plate 225 supporting a lower portion of the seat assembly 150.

The guide plate 225 may be located at a lower position than the insertion groove 221a. The guide plate 225 may be formed to support the bottom surface of the seat assembly 150 when the seat frame 100 is connected to the back frame 200.

In detail, the guide plate 225 may extend in a lateral direction such that the center portion of the first side frame 221 and the center portion of the second side frame 222 are connected to each other.

The low frame 230 may be connected to lower ends of the side frames 221 and 222. In detail, the low frame 230 may extend from the lower end of the first side frame 221 to the lower end of the second side frame 222. That is, the low frame 230 may extend in a lateral direction to connect the lower end of the first side frame 221 and the lower end of the second side frame 222.

In addition, the low frame 230 may be disposed to have a predetermined inclination in the front-rear direction. That is, the low frame 230 may extend to be inclined with the ground in the front-rear direction.

In detail, the rear end of the low frame 230 may be located higher than the front end of the low frame 230. That is, the low frame 230 may extend to be inclined upward from the front end to the rear.

In summary, the low frame 230 may extend to connect the side frames 221 and 222 in a lateral direction and may extend to be inclined such that the front end is located below the rear end in the front-rear direction.

Due to this, there is an advantage that the detection ranges of the rear height difference sensors 271 and 272, which will be described later, installed in the low frame 230 are further expanded to the rear.

That is, when the motorized wheelchair 1 moves backwards, the rear height difference sensors 271 and 272 may identify the height difference with respect to the running surface (or the ground) even at a farther distance. Therefore, it is possible to improve driving safety even at a relatively high speed.

Here, the inclined surface extending in the front-rear direction of the low frame 230 may be formed to have an acute angle with the running surface (or the ground). For example, the inclined surface of the low frame 230 may be formed to have an angle with the running surface at an angle of 0˜60°.

The low frame 230 may be provided with the rear height difference sensors 271 and 272 to face the running surface (or the ground). Therefore, when the inclined surface of the low frame 230 has an angle greater than an acute angle with the running surface, an area sensed by the rear height difference sensors 271 and 272 may exceed an allowable range. Accordingly, a factor other than a running surface is recognized, and a problem, such as misrecognition, may be caused. As a result, in order to optimize the performance of the rear height difference sensors 271 and 272, the inclined surface of the low frame 230 may extend to be inclined to have an acute angle with the running surface.

The motorized wheelchair 1 may further include the rear height difference sensor 271 or 272 installed on the bottom of the back frame 200, the control box 250 provided with a plurality of electronic parts, the rear obstacle detecting sensor 261 or 262 installed in the control box 250, and the main wheels 280 and 290 positioned at both lower ends of the side frames 221 and 222.

The rear height difference sensors 271 and 272 may be connected to the low frame 230 to face the running surface in order to detect a height difference of the running surface (or the ground) when the motorized wheelchair 1 moves backward.

The rear height difference sensor 271 or 272 may include an infrared position sensitive device (PSD).

The rear height difference sensor 271 or 272 may be provided in plurality. For example, the rear height difference sensors 271 and 272 may include a first rear height difference sensor 271 and a second rear height difference sensor 272 spaced apart laterally from the first rear height difference sensor 271.

The rear height difference sensor 271 or 272 may be provided to have the same configuration as the front height difference sensor 170. Therefore, the description of the front height difference sensor 170 will be used for a detailed description of the overlapping configuration of the rear height difference sensors 271 and 272 and the front height difference sensor 170.

The control box 250 may be installed at the lower end of the back frame 200. Specifically, the control box 250 may be supported by the inner surfaces of the side frames 221 and 222 and the inner surface of the low frame 230. The low frame 230 may form a surface supporting the control box 250.

The control box 250 may be provided with a plurality of electronic parts therein. For example, the plurality of electronic parts may include an inverter, a converter, a microcomputer, a main board, a plurality of PCBs, or the like.

The control box 250 may be provided with a plurality of electronic parts therein. For example, the plurality of electronic parts may include an inverter, a DC converter, a microcomputer, a main board, and a plurality of PCBs.

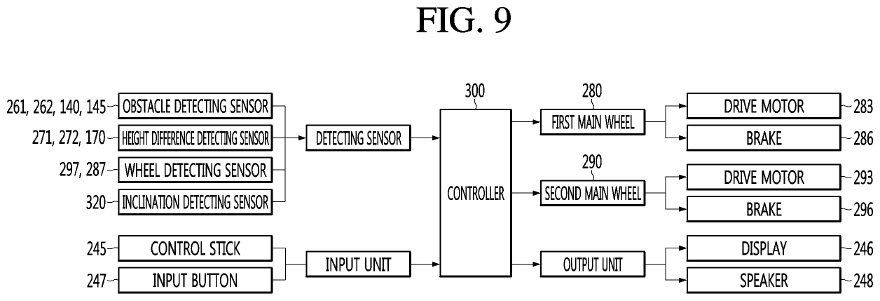

That is, the motorized wheelchair 1 may further include a controller 300 (FIG. 9) for controlling each component.

The control box 250 may include a box case 251 that protects the plurality of electronic parts. The box case 251 may extend from the front end of the low frame 230 to the rear end of the low frame 230 such that both side ends thereof are connected to the first side frame 221 and the second side frame 222. For example, the box case 251 may extend upward from the front end of the low frame 230 and be bent backward to be rounded, and then extend downward to the rear end of the low frame 230.

In addition, a board plate to which the plurality of electronic parts are connected may be located in an inner space formed by the box case 251.

The rear obstacle detecting sensor 261 or 262 may be installed in the control box 250. In detail, the rear obstacle detecting sensor 261 or 262 may be installed in the rear surface of the box case 251. The rear obstacle detecting sensor 261 or 262 may be connected to the box case 251 to be exposed to the outside.

The rear obstacle detecting sensors 261 and 262 may include an ultrasonic sensor (USS).

The rear obstacle detecting sensors 261 and 262 may be provided to have the same configuration as the front obstacle detecting sensors 261 and 262. Accordingly, the overlapping configuration of the rear obstacle detecting sensors 261 and 262 and the front obstacle detecting sensors 140 and 145 may quote from the description of the front obstacle detecting sensors 140 and 145.

Since the low frame 230 extends to be inclined in the front-rear direction, the rear surface of the box case 251 may also have a predetermined tilt with the ground. For example, the low frame 230 and the rear surface of the box case 251 may have a shape of ‘<’ when viewed from the side.

Thus, the rear obstacle detecting sensors 261 and 262 may be installed to be inclined relatively upward. Accordingly, the rear obstacle detecting sensors 261 and 262 may monitor the rear region of the motorized wheelchair 1 more widely.

The rear obstacle detecting sensor 261 or 262 may be provided in plurality. For example, the rear obstacle detecting sensors 261 and 262 may include a first rear obstacle detecting sensor 261 and a second rear obstacle detecting sensor 262 laterally spaced apart from the first rear obstacle detecting sensor 261.

The rear obstacle detecting sensor 261 or 262 may further include a light emitting case 263.

The light emitting case 263 may be provided with a light emitting diode (LED). Therefore, the light emitting case 263 may provide light according to an operation mode of the motorized wheelchair 1. For example, the light emitting case 263 may provide light in various colors according to various operating environments such as whether a rear obstacle is detected, whether a brake of the motorized wheelchair 1 is activated, or whether the motorized wheelchair 1 moves backward.

The light emitting case 263 may be located in the rear surface of the box case 251. The light emitting case 263 may elongate in a lateral direction to cover the first rear obstacle detecting sensor 261 and the second rear obstacle detecting sensor 262.

The main wheels 280 and 290 may be located at both sides of the control box 250.

Wheel shafts (not shown) that support the main wheels 280 and 290 and a bracket that connects the wheel shafts may be installed in inner surfaces of the side frames 221 and 222.

The bracket may be connected to the side frames 221 and 222 to fix the wheel shafts, and the wheel shafts may be respectively connected to the drive motors 283 and 293 of the main wheels 280 and 290. As an example, the wheel shaft may be connected to stators of the drive motors 283 and 293.

The wheel shafts and the bracket may be located in the lower portions of the side frames 221 and 222. For example, the wheel shafts may be exposed to the outside by passing through the outer surfaces of the lower ends of the side frames 221 and 222.

The main wheels 280 and 290 may be located at both lower ends of the back frame 200. That is, the main wheels 280 and 290 may be connected to the lower portions of the side frames 221 and 222 to provide a force for running of the motorized wheelchair 1.

The main wheel 280 may include the first main wheel 280 and the second main wheel 290.

The first main wheel 280 may be installed below the first side frame 221. The second main wheel 290 may be installed below the second side frame 222.

In detail, the first main wheel 280 may be connected to a wheel shaft connected to the first side frame 221. The second main wheel 290 may be connected to a wheel shaft connected to the second side frame 222.

Meanwhile, each of the main wheels 280 and 290 may include a wheel case 281, a tire 285, a drive motor 283 or 293 (see FIG. 9), a wheel detecting sensor 287 or 297 (see FIG. 9), and a brake 286 or 296 (see FIG. 9).

The wheel case 281 may be provided to cover an upper portion of the tire 285.

The drive motor 283 may receive power from the battery. The drive motors 283 and 293 may provide driving force to rotate the main wheels 280 and 290. That is, the main wheels 280 and 290 may perform rolling motion by the operation of the drive motors 283 and 293.

As a result, the motorized wheelchair 1 may run on the ground by driving the main wheels 280 and 290. In addition, since the sub wheels 181 and 182 are dependent on the driving of the main wheels 280 and 290 to perform rolling motions, the sub wheels 181 and 182 may assist the motorized wheelchair 1 in running stably.

The drive motors 283 and 293 may be connected to wheel shafts (not shown) connected to the side frames 221 and 222. Furthermore, the drive motor 283 or 293 may include an outer rotor type. As an example, stators of the drive motors 283 and 293 may be connected to the wheel shafts. Rotors of the drive motors 283 and 293 may be disposed to surround the outer circumference of the stator.

The drive motors 283 and 293 may include a first drive motor 283 provided in the first main wheel 280 and a second drive motor 293 provided in the second main wheel 290.

The main wheels 280 and 290 may include a rim extending in a radial direction from the rotors of the drive motors 283 and 293. The tire 285 may be installed along the outer circumference of the rim.

The brakes 286 and 296 may be installed on the rims. Therefore, when the brakes 286 and 296 are operated, the rotation of the main wheels 280 and 290 may be stopped quickly.

The brakes 286 and 296 may include a first brake 286 provided in the first main wheel 280 and a second brake 296 provided in the second main wheel 290.

The wheel detecting sensors 287 and 297 may detect rotational speeds of the main wheels 280 and 290. For example, the wheel detecting sensors 287 and 297 may be connected to the side frames 221 and 222 at one side positions corresponding to the rotors of the drive motors 283 and 293. The wheel detecting sensors 287 and 297 may include a Hall sensor.

The motorized wheelchair 1 may further include armrests 241 and 242 connected to the outer surface of the back frame 200.

The armrests 241 and 242 may be portions supporting the user's arms or hands. The armrests 241 and 242 may have a triangular shape and may be rotatably connected to both sides of the back frame 200, respectively. For example, the armrests 241 and 242 may be hinged to the back frame 200.

The armrests 241 and 242 may include a first armrest 241 connected to a first side frame 221 and a second armrest 242 connected to a second side frame 222. For example, the first armrest 241 may support the user's right arm, and the second armrest 242 may support the user's left arm.

The motorized wheelchair 1 may further include input units 245 and 247 for receiving a user input and output units 246 and 248 for outputting information.

The input units 245 and 247 and the output units 246 and 248 may be installed on the armrests 241 and 242. For example, the input units 245 and 247 and the output units 246 and 248 may be installed on the first armrest 241 or the second armrest 242.

The input units 245 and 247 and the output units 246 and 248 may be detachably connected to the armrests 241 and 242. For example, the input units 245 and 247 and the output units 246 and 248 may be formed as one module. The input units 245 and 247 and the output units 246 and 248 may be configured to be fitted rearward from front ends of the armrests 241 and 242.

Therefore, when the user is right-handed, the input units 245 and 247 and the output units 246 and 248 may be easily installed on the first armrest 241. On the contrary, when the user is left-handed, the input units 245 and 247 and the output units 246 and 248 may be easily removed from the first armrest 241 frontward and installed on the second armrest 242.

The input units 245 and 247 may include the control stick 245 for controlling a running direction, a speed, and the like of the motorized wheelchair 1.

The control stick 245 may be provided to be able to move up, down, left and right and rotate 360 degrees. The control stick 245 may control movement directions of the main wheels 280 and 290.

That is, the control stick 245 may be understood as a steering device of the motorized wheelchair 1. Therefore, the user may determine the running direction of the motorized wheelchair 1 by moving the stick while holding the stick.

In addition, the user may increase the rotational speed of the main wheels 280 and 290 by maintaining the control stick 245 in a moving state for a predetermined time in a direction that matches the running direction of the motorized wheelchair 1. In addition, when the user maintains the control stick 245 in a direction opposite to the running direction of the motorized wheelchair 1 by 180 degrees for a predetermined time, it is possible to decrease the rotational speed of the main wheels 280 and 290. Accordingly, the user may simply control the speed and the running direction of the motorized wheelchair 1.

In addition, the control stick 245 may be provided with a vibrating device. In addition, the vibrating device may be operated by receiving a command signal from the controller 300. For example, when an obstacle is detected during running of the motorized wheelchair 1 or a height difference is detected on the running surface, the controller 300 may generate vibration in the control stick 245 by operating the vibrating device.

Accordingly, the user may perceive risk information by tactile sense.

In addition, the input units 245 and 247 may further include an input button 247 formed in front of the control stick 245.

The input button 247 may be provided so as to allow a user to easily input various convenience functions of the motorized wheelchair 1.

Of course, the control stick 245 may be provided with a plurality of input buttons. The buttons provided in the control stick 235 may be used as an input device for control convenience for the user.

The output units 246 and 248 may include a display 246 that displays visual information and a speaker 248.

The display 246 may be located at the front end of the armrest 241 or 242. The display 246 may be installed to be inclined upward from the front end of the armrest 241 or 242. Accordingly, the direction of the display 246 coincides with the user's gaze direction which is directed downward, thus enabling the user to comfortably check the display 246.

The display 246 may display various information of the motorized wheelchair 1. For example, the display 246 may output various screens such as a running speed, a running path, whether an obstacle is detected, whether a height difference is detected, a warning message, a user input menu or the like of the motorized wheelchair 1.

The controller 300 may determine an environment that may adversely affects safety while running of the motorized wheelchair 1 based on detection signals received from the obstacle detecting sensors 140, 145, 261 and 262, the height difference sensors 170, 271 and 272 and the rear camera 215, and allow the display 246 to display risk information.

Accordingly, the user may recognize the risk information visually.

In addition, the display 246 may include a touch type display capable of enabling a touch input. For example, the user may check a message output on the display 246 and perform a related input by touching at least one of the display 246, the input button 247, and the control stick 245.

The speaker 248 may be installed together on a cover accommodating the display 246. As one example, the speaker 248 may be located behind the display 246. Of course, the installation position of the speaker 248 is not limited thereto.

The speaker 248 may operate by receiving a command signal from the controller 300. For example, when an obstacle is detected in the running direction of the motorized wheelchair 1, the controller 300 may allow the speaker 248 to output sounds having different frequencies and magnitudes according to a distance from the obstacle that is approaching.

In this way, the user may perceive the risk information by hearing.

That is, the motorized wheelchair 1 according to an embodiment of the present disclosure may provide a plurality of notification means 235, 246, and 248 that allow the user to recognize risk factors during running with the user's tactile, visual, and auditory senses which are determined by the plurality of detecting sensors 140, 145, 170, 261, 262, 271, 272, and 215.

Therefore, even when one of the sensory organs does not function properly in terms of the characteristics of the user who uses the motorized wheelchair 1, the motorized wheelchair 1 may be safely operated and driven.

The front obstacle detecting sensors 140 and 145 and the front height difference sensor 170 may be referred to as a “front detecting sensor”. In addition, the rear obstacle detecting sensors 261 and 262, the rear height difference sensors 271 and 272 and the rear camera 215 may be referred to as a “rear detecting sensor”.

Referring to FIG. 3, the motorized wheelchair 1 according to an embodiment of the present disclosure may include a first part 10 and a second part 20 which are detachably connected to each other.

The first part 10 may be configured to support the lower body of the user, and the second part 20 may be configured to support the upper body of the user.

Accordingly, the first part 10 may be referred to as a “seating part”, and the second part 20 may be referred to as a “backrest part”.

The first part 10 may include the seat frame 100, the seat assembly 150, the foot guide 160, and the sub wheels 181 and 182.

In addition, the front detecting sensors 140, 145, and 170 may be installed in the first part 10.

The second part 20 may include the back frame 200, the back plate 211, the cushion 212, the guide plate 225, the armrests 241 and 242, the control stick 245, the display 246, the input button 247, the speaker 248, the control box 250, and the main wheels 280 and 290.

The rear detecting sensors 261, 262, 271, and 272 may be installed in the second part 20.

The motorized wheelchair 1 may connect or separate the first part 10 to or from the second part 20 depending on whether the motorized wheelchair 1 is used. For example, when the motorized wheelchair 1 is used, the first part 10 may be slidably inserted into the second part 20. On the other hand, when the motorized wheelchair 1 is not used, the first part 10 may be slidably drawn out from the second part 20.

Accordingly, the first part 10 may be easily separated from and the second part 20, thus facilitating the storage and transportation of the motorized wheelchair 1.

In addition, the separated first part 10 may be fitted into the second part 2 in a state of being stacked on the second part 20. Accordingly, since the total volume of the motorized wheelchair 1 becomes small, the motorized wheelchair 1 may be stored in a relatively small space.

Meanwhile, the first part 10 and the second part 20 may be electrically connected to each other only when the first part 10 is completely inserted into the second part 20. That is, the first part 10 and the second part 20 may be provided in a switch structure that is turned on and off (ON/OFF) to conduct electricity depending on whether they are connected to each other.

For example, the first part 10 may have a contact formed in the seat frame 100 supporting the seat assembly 150. The second part 20 may have a contact formed in the insertion groove 221a into which the seat frame 100 is slidably inserted.

Therefore, when the first part 10 and the second part 20 are connected to each other, the contact of the first part 10 is in contact with the contact of the second part 20, so that an on state in which electricity is conducted is achieved. In addition, the motorized wheelchair 1 may operate normally when the first part 10 and the second part 20 are electrically connected to each other.

On the other hand, when the first part 10 and the second part 20 are separated from each other, the contact of the first part 10 is not in contact with the contact of the second part 20, so that an off state in which electricity is not conducted is achieved.

Accordingly, since the electrical connection between the first part 10 and the second part 20 is broken when the first part 10 and the second part 20 are separated from each other, it is impossible to force the motorized wheelchair to operate. As a result, the safety of the motorized wheelchair 1 may be improved.

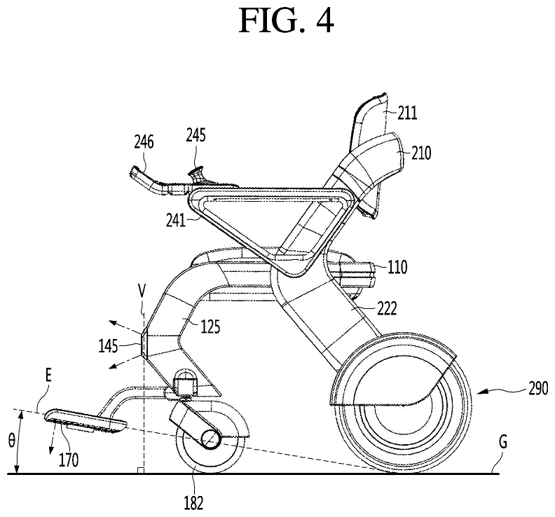

FIG. 4 is a side view showing a motorized wheelchair according to an embodiment of the present disclosure, and FIG. 5 is a perspective view showing a seat frame and a front obstacle detecting sensor according to an embodiment of the present disclosure.

Hereinafter, the structural features of the motorized wheelchair 1 according to the embodiment of the present disclosure will be described in detail so as to maximize the sensing range of the front obstacle detecting sensor 140 or 145 and minimize the misrecognition.

Referring to FIGS. 4 and 5, as described above, the front obstacle detecting sensors 140 and 145 may be connected to the front end of the seat frame 100.

In addition, the front obstacle detecting sensors 140 and 145 may include a first front obstacle detecting sensor 140 connected to the first leg frame 121, and a second front obstacle detecting sensor 145 connected to the second leg frame 125.

The front obstacle detecting sensors 140 and 145 may be installed to minimize structural interference with other components.

In detail, the seat frame 100 may form a cutout groove 126 to which the front obstacle detecting sensors 140 and 145 are connected.

The cutout groove 126 may be formed in each of the first leg frame 121 and the second leg frame 125.

As described above, the cutout groove 126 may be located in the most forward portions of the leg frames 121 and 125. The cutout groove 126 may be formed at a position higher than the upper end of the front frame 130.

In more detail, the cutout groove 126 may be located at a height corresponding to the point L2 at which the extending directions of the leg frames 121 and 125 are bent backwards.

Due to this, the front obstacle detecting sensors 140 and 145 connected to the cutout groove 126 may be installed at a position where structural interference of the motorized wheelchair 1 is minimized in the vertical direction, thereby improving reliability of front obstacle detecting.

On the other hand, when the cutout groove 126 is formed to be inclined downward, the front obstacle detecting sensors 140 and 145 may cause a problem in the recognition of the obstacle due to the structural interference by the foot guide 160. On the contrary, when the cutout groove 126 is formed to be inclined upward, the blind spots in which the front obstacle detecting sensors 140 and 145 are hard to detect obstacles may be caused in a space from the motorized wheelchair 1 to the front ground G.

In order to solve such problems, the cutout groove 126 may be formed with a surface perpendicular to the ground G in the front surface of the leg frame 121 or 125. For example, the cutout groove 126 may be formed by cutting the front surface of the leg frame 121 or 125 such that one plane is formed on a vertical line V perpendicular to the ground G.

Due to this, since the front obstacle detecting sensors 140 and 145 are disposed without tilting, the blind spot of the sensing space for sensing the front area of the motorized wheelchair 1 may be minimized. That is, the blind spot of a space for detecting obstacles may be minimized. Therefore, it is possible to optimize detection performance for front obstacles.

The cutout groove 126 may be formed with a coupling hole 128 to which the front obstacle detecting sensor 140 or 145 is connected.

The rear surface of the front obstacle detecting sensors 140 or 145 may be fixed to the coupling hole 128. For example, a rear surface of the front obstacle detecting sensor 140 or 145 may be formed with a locking protrusion engaging with the coupling hole 128.

The front obstacle detecting sensors 140 and 145 may include sensor cases 141 and 146.

The sensor cases 141 and 146 may be formed to cover the cutout grooves 126. For example, the sensor case 141 or 146 may extend forward along the circumference of the cutout groove 126 and may be formed with an opening in the front surface thereof.

The front obstacle detecting sensors 140 and 145 may include an ultrasonic sensor USS. In this case, a part for performing generation and detection of sound wave in an ultrasonic sensor may be located in the opening formed in the front surface of the sensor case 141 or 146.

The sensor case 141 or 146 may be provided with a light emitting diode (LED). Accordingly, the sensor case 141 or 146 may output light indicating the operating states of the front obstacle detecting sensor 140 or 145. For example, the color emitted from the sensor case 141 or 146 may be different according to the on or off state of the front obstacle detecting sensor 140 or 145.

The sensor cases 141 are 146 may be installed in the first leg frame 121 and the second leg frame 125 respectively.

That is, the sensor cases 141 and 146 may include a first sensor case 141 provided in the first front obstacle detecting sensor 140 and a second sensor case 146 provided in the second front obstacle detecting sensor 145.

On the other hand, the front height difference sensor 170 may be located in the front portion of the foot guide 160. In addition, the front height difference sensor 170 may perform a function of detecting a height difference (step) of a running surface when the motorized wheelchair 1 runs forward.

The motorized wheelchair 1 may run at a relatively high speed. Therefore, when the height difference of the running surface of the motorized wheelchair 1 is not detected and identified in advance, the motorized wheelchair 1 may be overturned or an accident may occur that the user falls.

Therefore, the front height difference sensor 170 needs to be able to search the running surface located in the running direction with more earlier, faster and wider.

To this end, the front height difference sensor 170 installed in the foot guide 160 according to an embodiment of the present disclosure may be disposed to be inclined upward toward the front.

Hereinafter, the configuration of the foot guide 160 will be described in detail with reference to FIG. 4.

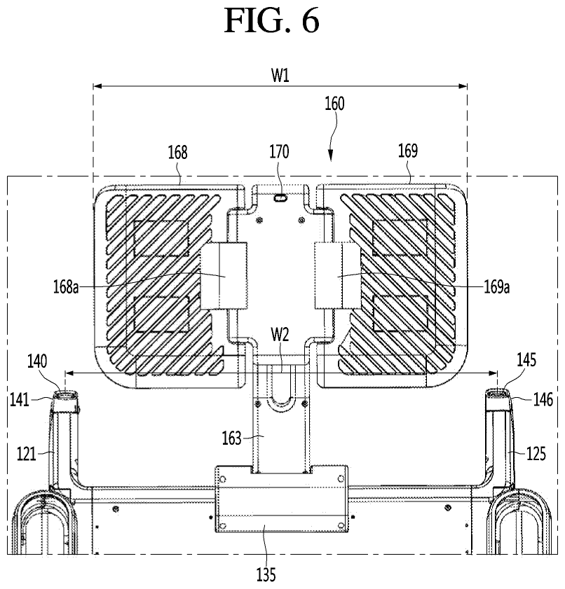

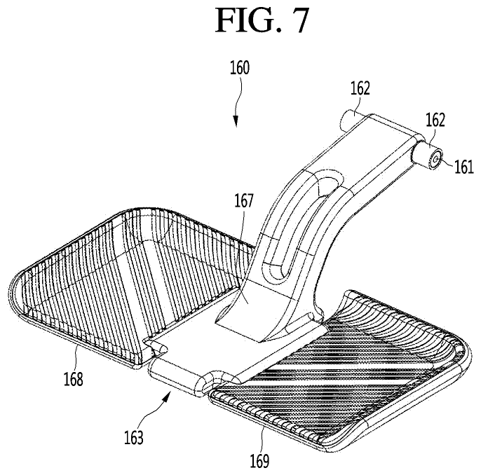

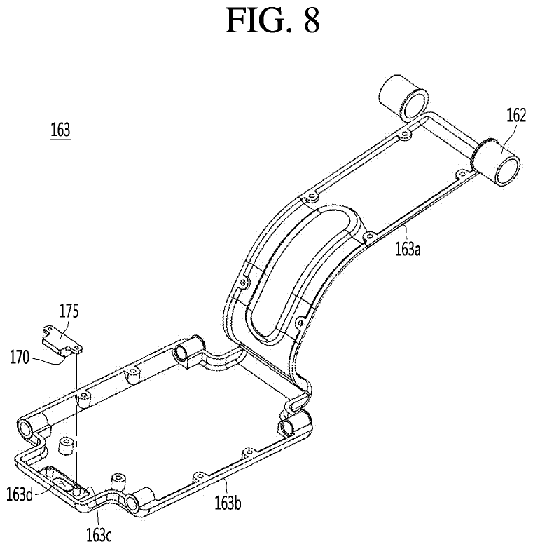

FIG. 6 is a bottom view showing a seat frame and a foot guide connected to each other according to an embodiment of the present disclosure, FIG. 7 is a perspective view showing a foot guide according to an embodiment of the present disclosure, and FIG. 8 is an exploded view showing some components of a foot guide according to an embodiment of the present disclosure.

Hereinafter, a position where the foot guide 160 has been fully rotated forward in a counterclockwise direction to support both feet of the user is referred to as a “normal position”. On the contrary, when the foot guide 160 is not used, the position where the foot guide 160 has been fully rotated upward in a clockwise direction to minimize the volume of the motorized wheelchair 1 is referred to as a “rotation position”.

Referring to FIGS. 4, and 6 to 8, the foot guide 160 may include a rotating shaft 161 connected to the hinge part 135 of the front frame 130 and bushes 162 fitted to the rotating shaft 161.

As described above, the rotating shaft 161 may be rotatably connected to shaft insertion holes 136 formed in both side surfaces of the hinge part 135.

The bushes 162 may be provided to minimize wear caused by the rotation of the rotating shaft 161. For example, the bushes 162 may be fitted to both sides of the rotating shaft 161, respectively. The bushes 162 may be connected to the shaft insertion holes 136 together with the rotating shaft 161.

In addition, the foot guide 160 may further include a rotating plate 163 and a rotating cover 167 through which the rotating shaft 161 passes.

The rotating plate 163 and the rotating cover 167 may be integrally formed. In detail, the rotating plate 163 may form a base surface extending forward from the rotating shaft 161. The rotating cover 167 may be connected along the circumference of the rotating plate 163 to cover the upper portion of the rotating plate 163. For example, the rotating cover 167 may be formed in a shape corresponding to the rotating plate 163.

The rotating plate 163 and the rotating cover 167 may rotate together with the rotation of the rotating shaft 161.

When the rotating guide 160 reaches the rotation position, the rotating plate 163 may be positioned above the hinge part 135. When the rotating guide 160 reaches the normal position, the rotating plate 163 may be located in front of the hinge part 135.

That is, the rotating plate 163 may rotate in a clockwise direction around the central axis of the rotating shaft 161.

The rotating shaft 161 may pass through the rotating plate 164 and the rotating cover 167 in both side directions. The rotating shaft 161 may be located at the rear end of the rotating plate 163 and the rotating cover 167.

The rotating plate 163 may extend forward such that the front end is positioned to be lower than the rear end. The rear end of the rotating plate 163 may extend in a circular shape to surround the rotating shaft 161.

In detail, the rotating plate 163 may include a bent portion 163a extending downward from the rear end toward the front and an extension 136b extending to be inclined upward from the bent portion 163a toward the front.

The bent portion 163a may be bent to extend to be rounded downward. For example, the bent portion 163a may form an extension surface that is rounded to be convex forward. In addition, the bent portion 163a may form a hole in the center portion for weight reduction.

The extension 163b may be located at a lower position than the bent part 163a. In addition, the extension 163b may extend such that the front end is located at a higher position than the rear end connected to the bent portion 163a.

In detail, the extension 163b may extend to be inclined upward from the front end of the bent portion 163a toward the front. For example, the extension 163b may extend forward to have a first angle θ (see FIG. 4) with reference to the ground G. The first angle θ may be set to an angle greater than 0° and less than 60°. That is, the extension 163b may extend to become higher toward the front.

When the extension 163b extend to have an angle greater than the first angle θ, the misrecognition rate of the front height difference sensor 170 installed in the extension 163b becomes relatively high, which may cause a problem that the user feels uncomfortable when the user's feet are supported.

In other words, the bottom surface of the rotating plate 163 may extend along an imaginary extension line E that forms the first angle θ with the ground G. Due to this, the height sensing range and accuracy of the front height difference sensor 170 may be improved.

In addition, an installation groove 163c recessed downward may be formed at a front end portion of the extension 163b.

The installation groove 163a may be formed with a sensor exposure hole 163d that is open downward.

The front height difference sensor 170 may be inserted into the sensor exposure hole 163d. Therefore, the front height difference sensor 170 may be exposed to the outside through the sensor exposure hole 163d to detect a height difference of the running surface in front thereof.

That is, the front height difference sensor 170 may be connected to the installation groove 163c. In other words, the front height difference sensor 170 may be connected to the front end of the rotating plate 163.

The installation groove 163c may be formed with guide protrusions protruding upward to guide coupling with the front height difference sensor 170. For example, the guide protrusions may be inserted into holes of height difference brackets 175 formed at both side ends of the front height difference sensor 170. Therefore, the front height difference sensor 170 may be stably connected to the installation groove 163a.

As described above, the extension 163b may extend forward such that the rear end is disposed to be higher than the front end. The front height difference sensor 170 may be located at a front end of the extension 163b.

Therefore, when the foot guide 160 is in the normal position, the front height difference sensor 170 may be located in the most forward portion of the motorized wheelchair 1. In addition, the front height difference sensor 170 may be installed to be inclined upward to sense the ground (G) that is located relatively forward rather than the ground (G) located vertically downward of the rotating plate 163.

Due to this, when the motorized wheelchair 1 runs forward, the front height difference sensor 170 may detect a height difference of the running surface that is located relatively farther, thus improving the running safety of the motorized wheelchair 1.

That is, the front height difference sensor 170 may be disposed to be inclined upwardly with respect to the foot guide 160. Accordingly, the front height difference sensor 170 may sense the ground in front thereof at a relatively wider and farther distance.

Meanwhile, the foot guide 160 may further include footrest hinges 168a and 169a connected to both side ends of the rotating plate 163 and footrests connected to the footrest hinges 168a and 169a to support the feet of the user.

The footrests 168 and 169 may be hinged to the rotating plate 163 to be rotatable.

The footrest hinges 168a and 169a may include a first footrest hinge 168a connected to one side end of the extension 163b and a second footrest hinge 169a connected to the other side end of the extension 163b.

The first footrest hinge 168a and the second footrest hinge 169a may be connected to the extension 163b to be symmetrical with each other.

Each of the footrests 168 and 169 may be formed of a plate having a predetermined area to support a foot of a user.

The footrests 168 and 169 may include a first footrest 168 connected to the first footrest hinge 168a to be rotated and a second footrest 169 connected to and pivoted on the second footrest hinge 169a to be rotated. For example, the first footrest 168 may support the user's right foot, and the second footrest 169 may support the user's left foot.

In addition, when the footrests 168 and 169 are fully unfolded to support the feet of the user, the maximum width W1 of the footrests 168 and 169 may be smaller than the maximum width W2 of the front obstacle detecting sensors 140 and 145.

That is, the footrests 168 and 169 may extend in a lateral direction such that a length of an extending portion thereof is smaller than the distance W2 from the first front obstacle detecting sensor 140 to the second front obstacle detecting sensor 145.

Accordingly, the front obstacle detecting sensors 140 and 145 may perform an operation regardless of whether the foot guide 160 is rotated. That is, the front obstacle detecting sensors 140 and 145 are not subject to interference by the foot guide 160 in detecting the front obstacle even when the foot guide 160 is disposed in the rotation position, thereby improving running safety of the motorized wheelchair 1.

FIG. 9 is a block diagram showing a control configuration of a motorized wheelchair according to an embodiment of the present disclosure.

Referring to FIG. 9, in order to control the motorized wheelchair 1, a detecting sensor and an input unit provided in the motorized wheelchair 1 may provide information to the controller 300. Accordingly, the controller 300 may control operations of the main wheels 280 and 290 and the output unit based on the information.

The detecting sensor may include a front obstacle detecting sensor 140 and 145, the front height difference sensor 170, the rear obstacle detecting sensors 261 and 262, the rear height difference sensors 271 and 272, a rear camera 215, and the wheel detecting sensors 287 and 297.

The detecting sensor may detect risk factors of the surroundings for the safe driving of the motorized wheelchair 1.

The obstacle detecting sensors 140, 145, 261 and 262 may be provided as ultrasonic sensors USS to detect whether obstacles exist around the motorized wheelchair 1. Accordingly, the motorized wheelchair 1 may be prevented from colliding with a surrounding obstacle.

In addition, the height difference sensors 170, 271 and 272 are provided as a distance detecting sensor (PSD) to detect a height difference of the ground on which the motorized wheelchair 1 moves. Accordingly, the motorized wheelchair 1 may be prevented from running on the ground with a height difference greater than or equal to a set reference.

In addition, the rear camera 215 may provide a rear image of the motorized wheelchair 1.

In addition, the wheel detecting sensors 287 and 297 may be provided as Hall sensors to detect operating states of the main wheels 280 and 290. Accordingly, it is possible to determine the rotational speed of the drive motors 283 and 293, whether or not over-current occurs.

The input unit may include the control stick 245 and the input button 247.

The control stick 245 may be provided to adjust the running direction and the speed of the motorized wheelchair 1 while the user holds the control stick 245.

That is, the running direction of the motorized wheelchair 1 may be determined along the operation direction of the control stick 245.

The user may input a turning motion of the motorized wheelchair 1 by operating the control stick 245. The controller 300 may control the main wheels 280 and 290 by determining a turning direction so as to correspond to an operation direction of the control stick 245.

Furthermore, the control stick 245 may be provided with a vibrating device to stimulate the user's tactile sense. For example, the controller 300 may allow the vibrating device to vibrate based on information input from the detecting sensor, thus enabling the user to tactilely recognize a risk factor of surroundings.

The input button 247 may be provided in plurality. In addition, the input button 247 may be provided to facilitate the user's operation of various functions of the motorized wheelchair 1, such as ON/OFF of the battery power, switching of screens output to the display 246, heating operation provided in the seat 152, running route guidance or the like.

The output unit may include the display 246, the speaker 248, the sensor case 141 or 146 provided with a light emitting diode (LED), and the light emitting case 263. The display 246 may provide visual information to the user, and the speaker 248 may provide audio information to the user.

The controller 300 may control the display 236 and the speaker 248 based on information received from the input unit and/or the detecting sensor. For example, the controller 300 may allow the display 246 to output a warning text, a rear image, a running guidance screen, and the like. In addition, the controller 300 may allow the speaker 248 to output a warning sound, a voice guidance, or the like. In addition, the controller 300 may operate the light emitting diode to light a warning light through the sensor case 141 or 146 and the light emitting case 263.

In addition, the controller 300 may control operations of the main wheels 280 and 290 based on information input from the input unit and/or the detecting sensor. As an example, the controller 300 may control the drive motors 283 and 293 of the main wheels 280 and 290 to reduce the speed based on information on an obstacle detected by the obstacle detecting sensor 140, 145, 261 or 262.

In addition, the controller 300 may activate the brakes 286 and 296 of the main wheels 280 and 290 to perform an emergency braking based on the detected obstacle information. Accordingly, it is possible to prevent the collision between the motorized wheelchair 1 and the obstacle even when the user does not recognize the obstacle.

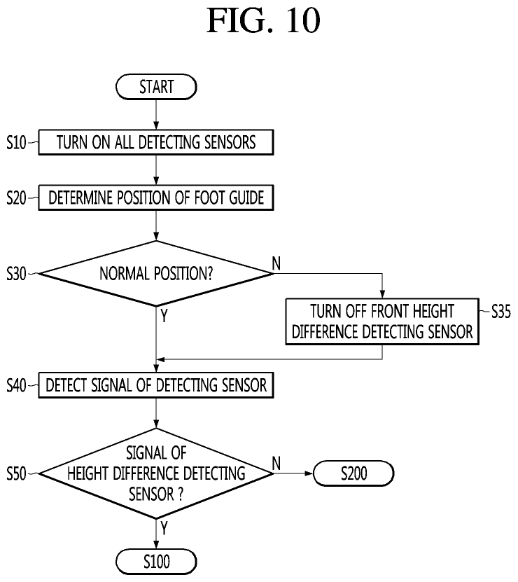

FIG. 10 is a flowchart of a method for controlling a motorized wheelchair according to an embodiment of the present disclosure.

Referring to FIG. 10, the motorized wheelchair 1 may operate the detecting sensors 140, 145, 261, 262, 170, 271, 272, 287, and 297 to search for a risk factor around the motorized wheelchair 1 while running. That is, the motorized wheelchair 1 may turn on the power supply of the detecting sensor. For example, the controller 300 may perform control to supply power to the detecting sensor from the battery (S10).

In addition, the motorized wheelchair 1 may determine a position of the foot guide 160 (S20).

As described above, the foot guide 160 is rotatably connected to the seat frame 100. The foot guide 160 is disposed at a normal position or a rotation position according to the rotation state.

The controller 300 may determine whether the foot guide 160 is the normal position or the rotation position by using the detection information of the front height difference sensor 170 installed in the foot guide 160.

When the foot guide 160 is in the rotation position, the front height difference sensor 170 may face the front, and thus a signal different from that at the normal position facing the ground may be generated. For example, the front height difference sensor 170 may provide the controller 300 with a signal returned by emitting infrared rays. Therefore, the controller 300 may determine a position of the foot guide 160 based on the signal input from the front height difference sensor 170.

In addition, the motorized wheelchair 1 may determine whether the position of the foot guide 160 is a normal position (S30).

When the position of the foot guide 160 is not the normal position, the motorized wheelchair 1 may turn off the power supply of the front height difference sensor 170 or exclude the front height difference sensor 170 when determining a risk factor of surroundings while running (S35).

That is, the front height difference sensor 170 may be selectively operated according to whether the foot guide 160 is rotated.

When the foot guide 160 is in the rotation position, the front height difference sensor 170 may face the front rather than the ground G. Therefore, the front height difference sensor 170 may not only hardly detect the height difference of the running surface, but also recognize the surrounding environment at a long distance, which may cause a problem in the reliability of detecting the height difference.

Therefore, the controller 300 may use a result of the detection of the front height difference sensor 170 only when the foot guide 160 is in the normal position. Due to this, when a user uses the motorized wheelchair 1 while the foot guide 160 is in the rotation position, a misrecognition of the front height difference sensor 170 may be solved.

Thereafter, the detecting sensor may detect a signal obtained by detecting an obstacle, a height difference (step) of the ground, or the like (S40).

In detail, the controller 300 may receive a detection signal detected from the front obstacle detecting sensors 140 and 145 installed at the front end of the seat frame 100 and the front height difference sensor 170 installed in the foot guide 160. Here, the detection signal may be defined as a signal for the detected obstacle and height difference.

For example, the front obstacle detecting sensors 140 and 145 may detect a signal for an obstacle and transmit the signal to the controller 300. In addition, the front height difference sensor 170 may detect a signal for a height difference of the ground and transmit the signal to the controller 300.

Therefore, the controller 300 may determine whether there is a risk factor around the motorized wheelchair 1 based on the detection signal provided from the detecting sensor.

In addition, the motorized wheelchair 1 may determine whether the detection signal is a signal detected by the front height difference sensor 170.

That is, the controller 300 may determine whether the detection signal provided from the detecting sensor is transferred from the front height difference sensor 170.

In addition, when it is determined that the detection signal is provided by the front height difference sensor 170, the motorized wheelchair 1 may start a height difference risk prevention step (S100) to avoid the detected height difference.

In addition, when the detection signal is provided by the front obstacle detecting sensor 140 or 145, the motorized wheelchair 1 may start the obstacle risk prevention step (S200) to prevent the collision with the detected obstacle.

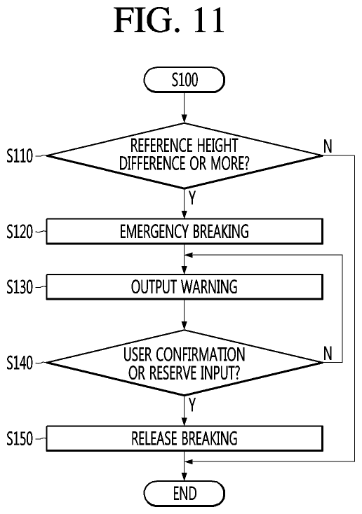

FIG. 11 is a flowchart illustrating step S100 of FIG. 10 in detail. That is, the flowchart shows the height difference risk prevention step (S100) in detail.

Referring to FIG. 11, in the height difference risk prevention step (S100), the motorized wheelchair 1 may determine whether a height difference (or a step) detected based on a detection signal by the front height difference detecting sensor 170 is greater than or equal to a preset reference height difference (S110).

The reference height difference may be set to a smaller one of a maximum value of a height difference (or a step) over which the motorized wheelchair 1 is able to run without overturning and a distance between a bottom surface of the foot guide 160 and a flat surface.

When the detected height difference is greater than or equal to the reference height difference, the motorized wheelchair 1 may perform an emergency braking (S120).

In detail, when the detected height difference is determined to be greater than or equal to the reference height difference, the controller 300 may allow the brakes 286 and 296 of the main wheels 280 and 290 to operate. Therefore, the rotation of the main wheels 280 and 290 may be stopped quickly to allow the motorized wheelchair 1 to stop.

The motorized wheelchair 1 may output a warning for the front height difference (step) to a user through at least one of the display 246, the speaker 248, and the control stick 245 (S130).

In detail, the controller 300 may allow the display 246 to output a warning screen indicating that a height difference greater than or equal to the reference height difference is located in front thereof. In addition, the controller 300 may allow the speaker 248 to output a warning sound and/or a warning guidance as a speech. In addition, the controller 300 may output a warning by allowing the vibrating device provided in the control stick 245 to operate. Accordingly, the user may recognize the fact that the height difference is detected through at least one of sight, hearing, and tactile sense.

As another example, the controller 300 may allow a warning light of the sensor case 141 or 146 and/or the light emitting case 263 to flicker. Due to this, it is possible to provide a warning for running of the motorized wheelchair 1 to the people around the motorized wheelchair 1.

The motorized wheelchair 1 may determine whether a user confirmation or reverse is input (S140).

Specifically, when the warning is output due to a malfunction or the like, the user may identify the height difference and then operate the input unit such that the motorized wheelchair 1 continuously runs forward. In one example, the user may select a continuous running on the warning screen output on the display 246. In addition, the user may push the control stick 245 forward to input the forward signal. In addition, the user may press the forward button provided in the input button 247 to input the forward signal.

In this case, the operation of the input unit for the forward of the motorized wheelchair 1 may be referred to as “user confirmation input”.

Alternatively, the user may operate the input unit to drive the motorized wheelchair 1 backward to avoid the height difference. In one example, the user may select a reverse on the warning screen output on the display 246. In addition, the user may pull the control stick 245 backward to input the backward signal. In addition, the user may press the reverse button provided in the input button 247 to input the reverse signal.

The above-mentioned user's operation of the input unit to drive the motorized wheelchair 1 forward may be referred to as “backward movement input”.

When it is determined that there is no user confirmation or backward movement input, the stopped state of the motorized wheelchair 1 may be maintained.

On the contrary, when it is determined that there is the user confirmation input or backward movement input, the motorized wheelchair 1 may release a braking state. The motorized wheelchair 1 may end the warning (S150).

In detail, when the user confirmation input is performed, the controller 300 may release the operations of the brakes 286 and 296 and control the drive motors 283 and 293 to normally rotate. Therefore, the forward running of the motorized wheelchair 1 may be continuously maintained.

On the other hands, when the reverse input is performed, the controller 300 may release the operation of the brakes 286 and 296 and control the drive motors 283 and 293 to reversely rotate. Therefore, the motorized wheelchair 1 may run backward.

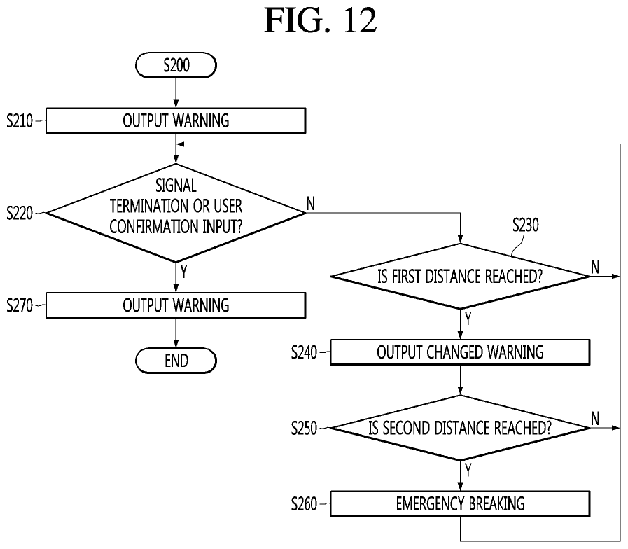

FIG. 12 is a flowchart illustrating step S200 of FIG. 10 in detail. That is, the flowchart shows the obstacle risk prevention step (S200) in detail.

Referring to FIG. 12, in the obstacle risk prevention step (S200), the motorized wheelchair 1 may output a warning for a front obstacle to a user through at least one of the display 246, the speaker 248, and the control stick 245.

Specifically, the controller 300 may allow the display 246 to output a warning screen indicating that there is an obstacle in front thereof. In addition, the controller 300 may allow the speaker 248 to output a warning sound and/or a warning guidance as a speech. In addition, the controller 300 may output a warning by allowing the vibrating device provided in the control stick 245 to operate. Accordingly, the user may recognize the fact that the obstacle is detected through at least one of sight, hearing, and tactile sense.

As another example, the controller 300 may allow a warning light of the sensor case 141 or 146 and/or the light emitting case 263 to flicker. Due to this, it is possible to provide a warning for running of the motorized wheelchair 1 to the people around the motorized wheelchair 1.

Thereafter, the motorized wheelchair 1 may determine whether the detection signal by the front obstacle detecting sensors 140 and 145 is terminated or whether the user confirmation input is performed (S220).

For example, when a front obstacle is a person moving ahead, the obstacle detection signal may be terminated from the front obstacle detecting sensors 140 and 145 after a predetermined time elapses.

In addition, when it is determined that the running is sufficiently performed, or when the warning is output due to a malfunction or the like, the user may operate the input unit such that the motorized wheelchair 1 runs forward after identifying the obstacle. That is, as described above, the user may perform a user confirmation input.

The motorized wheelchair 1 may continue running normally when the detection signal is terminated, or a user confirmation input is performed (S270).

However, when the detection signal is not terminated or the user confirmation input is not performed, the motorized wheelchair 1 may determine whether a distance to the obstacle reaches a first distance (S230).

In detail, the front obstacle detecting sensors 140 and 145 may include an ultrasonic sensor capable of detecting a distance. The controller 300 may continuously calculate the distance between the motorized wheelchair 1 and the obstacle based on the detection signal information input from the front obstacle detecting sensors 140 and 145. In addition, the motorized wheelchair 1 may determine whether a distance to the detected obstacle reaches the first distance.

When it is determined that the distance reaches the first distance, the motorized wheelchair 1 may change and output a warning (S240).

In detail, when it is determined that the first distance is reached, the controller 300 may change a warning through at least one of the display 246, the speaker 248, and the control stick 245 in order to warn the user against the obstacle that is gradually approaching.

For example, the controller 300 may perform control to enable a warning screen output to the display 246 to flicker or output a flickering screen on which red light is flickering. In addition, the control unit 300 may perform control to speed up the interval of the warning sound output to the speaker 248 or to change the speech of the warning guidance. In addition, the controller 300 may perform control to speed up the operation interval of the vibrating device or increase the vibration intensity. Accordingly, the user may recognize the fact that the obstacle is approaching through at least one of sight, hearing, and tactile sense.

Thereafter, the motorized wheelchair 1 may determine whether the distance to the obstacle reaches a second distance shorter than the first distance (S250).

On the other hand, when the first distance is not reached and the second distance is not reached, returning to step S220 may be performed.

In addition, when it is determined that the second distance is reached, the motorized wheelchair 1 may perform an emergency braking to prevent a collision (S260).

In detail, when it is determined that the distance detected by the front obstacle detecting sensor 140 or 145 has reached the second distance, the controller 300 may allow the brakes 286 and 296 of the main wheels 280 and 290 to be activated. Therefore, the rotation of the main wheels 280 and 290 may be stopped quickly to allow the motorized wheelchair 1 to stop. In addition, returning to step S220 may be performed.

What is claimed is:

1. A motorized wheelchair comprising:
a seat frame;
a seat assembly provided with a seat and connected to an upper portion of the seat frame;
a foot guide rotatably connected to a front end of the seat frame;
a back frame provided with a backrest connected to an upper portion thereof, the seat frame being slidably inserted into a center portion of the back frame;
main wheels connected to both lower ends of the back frame;
a front obstacle detecting sensor connected to a most forward portion of the seat frame to detect an obstacle in front of the seat frame; and
a front height difference sensor installed on the foot guide to face the ground to detect a height difference of the ground.

2. The motorized wheelchair of claim 1,
wherein the foot guide is disposed to be inclined upwardly such that a front end is higher than a lower end.

3. The motorized wheelchair of claim 1,
wherein the front height difference sensor is disposed to be inclined upwardly from the ground.

4. The motorized wheelchair of claim 1,
wherein the foot guide includes
a rotating shaft connected to a lower end of the seat frame; and
a rotating plate extending such that a front end is disposed to be lower than a rear end and formed such that the rear end surrounds the rotating shaft.

5. The motorized wheelchair of claim 4,
wherein the rotating plate is provided with a sensor exposing hole that is positioned at a front end and is open downwardly,
wherein the front height difference sensor is inserted into the sensor exposure hole.

6. The motorized wheelchair of claim 1, wherein the seat frame includes
a rear frame located on a rear side;
leg frames extending forward from both side ends of the rear frame; and
a front frame connecting the lower ends of the leg frames,
wherein the front obstacle detecting sensor is connected to front ends of the leg frames.

7. The motorized wheelchair of claim 6, wherein the leg frames extend from the rear frame to a first point (L1) in front of the leg frames and extend to be inclined downward from the first point to a second point (L2) positioned in front of the first point, and
wherein the front obstacle detecting sensor is connected to a cutout groove formed at a position corresponding to the second point.

8. The motorized wheelchair of claim 7, wherein the leg frames extend to be inclined downward from the second point (L2) to a third point (L3) positioned behind the second point.

9. The motorized wheelchair of claim 7, wherein the cutout groove forms a flat plane perpendicular to the ground.

10. The motorized wheelchair of claim 1, wherein the front obstacle detecting sensor includes a sensor case provided with a light emitting diode (LED).

11. The motorized wheelchair of claim 1, wherein the seat assembly further includes
a base plate supporting the seat; and
a battery fixed to a lower side of the base plate,
wherein the seat frame and the back frame are formed
in a structure of a switch for operations of turning on/off power provided from the battery.

12. A control method for a motorized wheelchair, the motorized wheelchair including a first part for seating of a user and a second part for a backrest which are detachably connected to each other, the method comprising:
determining a position of a foot guide rotatably connected to a lower end of a seat frame provided in the first part;
receiving a detection signal from one of a front obstacle detecting sensor installed in a front end of the seat frame and a front height difference sensor installed in the foot guide;
determining whether the detection signal is a signal of the front obstacle detecting sensor or a signal of the front height difference sensor;
performing an obstacle risk prevention of preventing collision with a detected obstacle when the detection signal is the signal of the front obstacle detecting sensor; and
performing a height difference risk prevention of avoiding a detected height difference when the detection signal is the signal of the front height difference sensor.

13. The method of claim 12, further comprising:
turning off the operation of the front height difference sensor when it is determined that the foot guide is at a position of being completely rotated upward.

14. The method of claim 12, wherein the position of the foot guide is determined based on the detection signal of the front height difference sensor.

15. The electrically powered wheelchair of claim 12, wherein the front height difference sensor is selectively operated according to rotation of the foot guide.

16. The method of claim 12, wherein the height difference risk prevention includes outputting a warning to at least one of a display, a speaker, and a control stick provided with a vibrating device which are provided in the second part.

17. The method of claim 16, wherein the height difference risk prevention further includes
determining whether the detected height difference is greater than or equal to a preset reference height difference; and
an emergency braking step of operating a brake of the main wheels provided in the second part when the detected height difference is greater than or equal to the reference height difference.

18. The method of claim 17, wherein the height difference risk prevention further includes
determining whether a user confirmation or a backward is input after the warning is output; and
releasing braking of the main wheels, when it is determined that the user confirmation or the backward is input.

19. The method of claim 12, wherein the obstacle risk prevention step includes
outputting a warning to at least one of a display, a speaker, and a control stick provided with a vibrating device which are provided in the second part;
determining whether the detection signal is or a user confirmation is input;
determining a distance to the obstacle when it is determined that the detection signal or there is no user confirmation input; and
changing the warning when a distance to the obstacle reaches a preset distance.

20. The method of claim 19, wherein the changing of the warning includes flickering of a warning screen output to the display, changing of an interval of a warning sound output to the speaker, and changing of vibration of the vibrating device.
